(19) United States
(12) Patent Application Publication
(10) Pub. No.: US 2025/0010573 A1
(43) Pub. Date: Jan. 9, 2025

(54) MEMBER

(71) Applicant: CANON KABUSHIKI KAISHA, Tokyo (JP)

(72) Inventor: JUNJI KAWASAKI, Kanagawa (JP)

(21) Appl. No.: 18/888,589

(22) Filed: Sep. 18, 2024

Related U.S. Application Data
(63) Continuation of application No. PCT/JP2023/005109, filed on Feb. 15, 2023.

(30) Foreign Application Priority Data
Mar. 30, 2022 (JP) 2022-056128

(51) Int. Cl. B32B 3/30; B32B 17/10

(52) U.S. Cl. CPC B32B 3/30; B32B 17/10; B32B 2250/02; B32B 2255/10; B32B 2255/26; B32B 2264/1021; B32B 2264/2032; B32B 2307/584

(57) ABSTRACT

To achieve a member including a resin base material, which is excellent in anti-reflection performance and is formed without using a vacuum process. The member includes: a resin base material having a surface with a fine uneven structure; and a porous layer made of a porous material containing particles formed on the resin base material so as to be positioned on the fine uneven structure side. The porous layer includes a filling portion defined by the porous material in an air gap of the fine uneven structure and a surface layer located on the fine uneven structure. A thickness of the surface layer is 150 nm or less. A height of the protruding portions or a depth of the recessed portions is 120 nm or less.

### CROSS-REFERENCE TO RELATED APPLICATIONS

This application is a Continuation of International Patent Application No. PCT/JP2023/005109, filed Feb. 15, 2023, which claims the benefit of Japanese Patent Application No. 2022-056128, filed Mar. 30, 2022, both of which are hereby incorporated by reference herein in their entirety.

### BACKGROUND OF THE INVENTION

### Field of the Invention

The present invention relates to a member including an anti-reflection structure, which is to be used as an optic element.

### Description of the Related Art

In recent years, plastic lenses have been more frequently used because, for example, the plastic lenses are less expensive than lenses of glass materials, and are lightweight and excellent in shock resistance. To reduce reflection at a surface of a lens, the lens requires an anti-reflection film. A multilayered anti-reflection film of a metal oxide, which is formed by vapor deposition, is common as the anti-reflection film as described in Japanese Patent Application Laid-Open No. 2005-241740. In Japanese Patent Application Laid-Open No. 2008-116348, there is described a method of forming an anti-reflection layer by using a coating liquid in which a hydrolysate of a silane compound and silica-based fine particles are dispersed in an organic solvent.

However, the multilayer anti-reflection film formed by vapor deposition as described in Japanese Patent Application Laid-Open No. 2005-241740 requires a vacuum process, which may result in a longer takt time. A coating film described in Japanese Patent Application Laid-Open No. 2008-116348 is preferred because the vacuum process is not required. However, it is not considered that the coating film has sufficient anti-reflection performance.

An object of the present invention is to provide a member including a resin base material, which is excellent in anti-reflection performance and is formed without using a vacuum process.

### SUMMARY OF THE INVENTION

According to one aspect of the present invention, there is provided a member including:
a resin base material having a surface with a fine uneven structure; and
a porous layer made of a porous material containing particles formed on the resin base material so as to be positioned on the fine uneven structure side,
wherein the porous layer includes:
   a filling portion defined by the porous material in an air gap of the fine uneven structure; and
   a surface layer located on the fine uneven structure,
wherein the fine uneven structure includes a two-dimensional periodic arrangement of columnar protruding portions or columnar recessed portions,
wherein a thickness of the surface layer is 80 nm or more and 150 nm or less,
wherein a distance between the protruding portions or the recessed portions is 20 nm or more and 300 nm or less, and a height of the protruding portions or a depth of the recessed portions is 10 nm or more and 120 nm or less.

Further features of the present invention will become apparent from the following description of exemplary embodiments with reference to the attached drawings.

### BRIEF DESCRIPTION OF THE DRAWINGS

FIG. 1A and FIG. 1B are schematic sectional views of a member according to an embodiment of the present invention, in which the member is used as an optical element.

FIG. 2 is a schematic sectional view for illustrating a basic configuration of the member according to the present invention.

FIG. 3A and FIG. 3B are perspective views for schematically illustrating examples of a fine uneven structure of a resin base material in the present invention.

FIG. 4A and FIG. 4B are schematic sectional views, each for illustrating details of a porous layer of an anti-reflection structure in the present invention.

FIG. 5 is a schematic sectional view of a member according to another embodiment of the present invention.

FIG. 6A, FIG. 6B, FIG. 6C, FIG. 6D and FIG. 6E are schematic sectional views for illustrating a process of manufacturing a molding die for a resin base material in the present invention.

FIG. 7A, FIG. 7B and FIG. 7C are schematic sectional views for illustrating an injection-molding process for the resin base material in the present invention.

FIG. 8 is a graph for showing a refractive-index model of the member according to the present invention.

### DESCRIPTION OF THE EMBODIMENTS

The present invention includes a member including: a resin base material having a surface with a fine uneven structure; and a porous layer made of a porous material formed on the resin base material so as to be positioned on the fine uneven structure side. In the present invention, the porous layer contains particles and includes: a filling portion defined by the porous material in an air gap of the fine uneven structure; and a surface layer located on the fine uneven structure. The fine uneven structure includes a two-dimensional periodic arrangement of columnar protruding portions or columnar recessed portions. Further, a thickness of the surface layer is 80 nm or more and 150 nm or less, a distance between the protruding portions or the recessed portions of the fine uneven structure is 20 nm or more and 300 nm or less, and a height of the protruding portions or a depth of the recessed portions is 10 nm or more and 120 nm or less.

Now, description is given of embodiments of the present invention with reference to the drawings. The present invention is not limited to the following embodiments, and the following embodiments, which are appropriately changed, modified, and the like based on the ordinary knowledge of a person skilled in the art without departing from the spirit of the present invention, are also encompassed within the scope of the present invention.

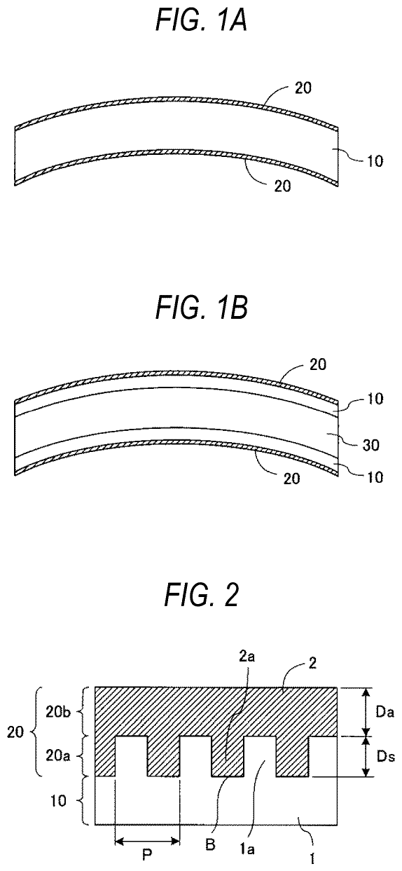

FIG. 1A is a schematic sectional view of a member according to an embodiment of the present invention, taken in a thickness direction, in which the member is used as an optical element. The optical element includes an anti-reflection structure 20 on at least one surface of a base material layer 10. In FIG. 1A, there is illustrated a configuration example in which the anti-reflection structures 20 are formed on both surfaces of the base material layer 10, respectively. Further, FIG. 1B is a schematic sectional view of a member according to another embodiment, which is taken in the thickness direction. The member is an optical element including the base material layers 10 laminated on a glass base material, which is generally referred to as “replica lens”. The base material layers 10 are laminated on both surfaces of a glass base material 30, respectively, and the anti-reflection structure 20 is formed on a surface of each of the base material layers 10.

FIG. 2 is a schematic sectional view for illustrating a basic configuration of the member according to the present invention, which is taken in the thickness direction. The member according to the present invention includes a resin base material 1 and a porous layer 2. In the member including the resin base material 1 having a fine uneven structure on its surface and the porous layer 2 formed on the fine uneven structure side, the anti-reflection structure 20 corresponds to a portion including the fine uneven structure and the porous layer 2.

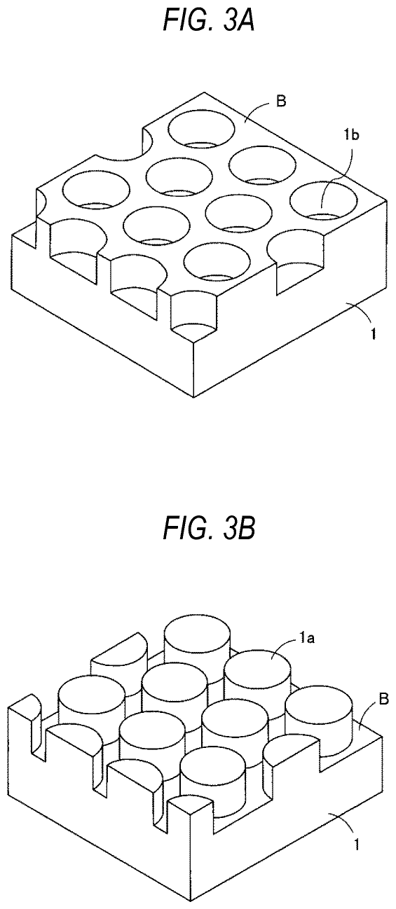

The fine uneven structure formed on the surface of the resin base material 1 in the present invention has columnar depressed portions or columnar projecting portions with respect to a reference surface B, as illustrated in perspective views of FIG. 3A and FIG. 3B. The columnar projecting portions are hereinafter referred to as “protruding portions 1a”, and the columnar depressed portions are hereinafter referred to as “recessed portions 1b”.

The porous layer 2 in the present invention is made of a porous material. In FIG. 2, the porous material is provided to fill an air gap defined by a plurality of the protruding portions 1a projecting from the reference surface B of the fine uneven structure to thereby form a filling portion 2a. Further, the porous material is also provided on the fine uneven structure to thereby form a surface layer 20b. Specifically, the porous layer 2 includes the surface layer 20b and the filling portion 2a. Further, in the present invention, a region including the fine uneven structure and the filling portion 2a, that is, a region including the protruding portions 1a of the resin base material 1 and the filling portion 2a of the porous layer 2 is referred to as “composite layer 20a” for convenience. In other words, the anti-reflection structure 20 includes the composite layer 20a and the surface layer 20b.

Further, when the resin base material 1 in the present invention has the columnar depressed portions as the recessed portions 1b as illustrated in FIG. 3A, the porous material is provided to fill the recessed portions 1b to thereby form the filling portion 2a. Further, the porous material is also provided on the fine uneven structure to thereby form the surface layer 20b. Specifically, similarly to FIG. 2, the porous layer 2 includes the surface layer 20b and the filling portion 2a. Further, in the present invention, the region including the fine uneven structure and the filling portion 2a, that is, a region including the resin base material 1 located between the recessed portions 1b and the filling portion 2a of the porous layer 2 is referred to as “composite layer 20a” for convenience. In other words, the anti-reflection structure 20 includes the composite layer 20a and the surface layer 20b.

When the resin base material 1 includes the columnar protruding portions 1a as illustrated in FIG. 3B, the base material layer 10 illustrated in FIG. 1A and FIG. 1B corresponds to the resin base material 1 without the protruding portions 1a and the reference surface B corresponds to a surface of the base material layer 10. In other words, the resin base material 1 includes the base material layer 10 and the protruding portions 1a in this case. Further, when the resin base material 1 has the columnar recessed portions 1b as illustrated in FIG. 3A, the base material layer 10 corresponds to the resin base material 1 without portions of the recessed portions 1b, which are deeper than the reference surface B. In other words, the resin base material 1 includes the base material layer 10 and an area defined by the recessed portions 1b in this case.

### [Fine Uneven Structure]

A refractive index of the composite layer 20a is determined by a volume ratio of the filling portion 2a to the composite layer 20a. Specifically, the refractive index can be adjusted by the fine uneven structure, and is appropriately adjusted in accordance with a refractive index of the resin base material 1 and a refractive index of the porous material of the filling portion 2a so that a reflectance is decreased. Preferably, the volume ratio of the filling portion 2a to the composite layer 20a is from 30% to 50%.

The fine uneven structure in the present invention has the columnar depressed portions or the columnar projecting portions with respect to the reference surface B of the resin base material 1, as illustrated in perspective views of FIG. 3A and FIG. 3B. The columnar projecting portions are hereinafter referred to as “protruding portions 1a”, and the columnar depressed portions are hereinafter referred to as “recessed portions 1b”. The columnar protruding portions 1a or the columnar recessed portions 1b are provided in a two-dimensional periodic arrangement. A sectional shape (shape of a cross section taken in a direction perpendicular to a center axis of a columnar shape) of the protruding portion 1a or the recessed portion 1b may be either circular or polygonal, and the protruding portions 1a or the recessed portions 1b, which have different shapes, may be formed in a mixed manner. For ease of manufacture, it is preferred that the protruding portions 1a or the recessed portions 1b have substantially the same shape.

Further, a planar arrangement of the protruding portions 1a or the recessed portions 1b may be a grid pattern in which rows of a plurality of protruding portions 1a or recessed portions 1b are arranged in a plurality of columns or a triangular lattice pattern in which the protruding portions 1a or the recessed portions 1b are positioned at vertices of each equilateral triangle. The columnar recessed portions 1b are arranged in a triangular lattice pattern in FIG. 3A, and the columnar protruding portions 1a are arranged in a triangular lattice pattern in FIG. 3B.

In the present invention, the protruding portion 1a or the recessed portion 1b is only required to have a substantially columnar shape. A side surface of the protruding portion 1a or the recessed portion 1b may be slightly inclined for a manufacturing reason. An angle (opening angle) of the side surface with respect to a center axis direction of the columnar shape is required to be 5 degrees or less.

In the present invention, a height of the protruding portion 1a or a depth of the recessed portion 1b, that is, a thickness Ds of the composite layer 20a is 10 nm or more and 120 nm or less. Further, a distance (pitch) P between the protruding portions 1a or the recessed portions 1b is preferably 20 nm or more and half a wavelength of target light, and thus is 20 nm or more and 300 nm or less with visible light being a target. When the distance P is set to fall within the above-mentioned range, a desirable anti-reflection effect on visible light is obtained. It is desired that the heights of the protruding portions 1a or the depths of the recessed portions 1b be the same and the distances between the protruding portions 1a or between the recessed portions 1b be the same. However, those values may be varied within the above-mentioned ranges.

### [Porous Layer]

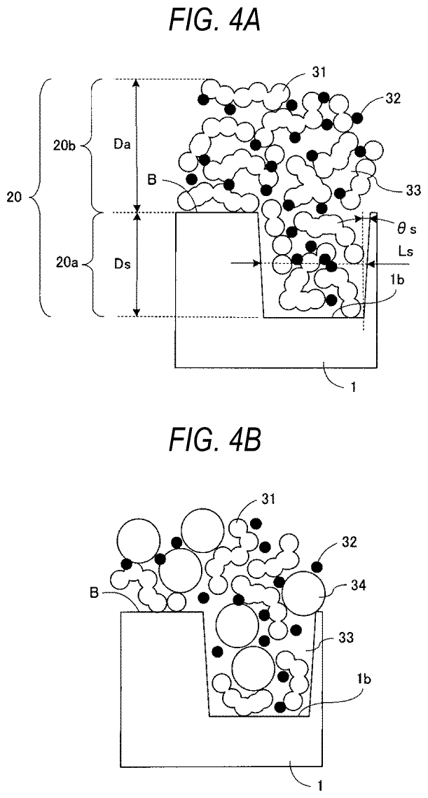

FIG. 4A and FIG. 4B are schematic sectional views taken in the thickness direction, for each illustrating details of the porous layer in the present invention. The porous layer 2 is made of a porous material containing particles, and has a double-layer structure including the filling portion and the surface layer 20b. The recessed portions 1b of the fine uneven structure are filled with the filling portion, and the surface layer 20b is formed on the fine uneven structure. In FIG. 4A and FIG. 4B, there are illustrated examples in which the recessed portions 1b are formed as the fine uneven structure. However, the protruding portions may be formed as the fine uneven structure in the same manner.

In the porous layer 2, particles 31, 34 contained in the porous material are bound to each other with binders 32 to thereby define an air gap 33 between the particles. In this manner, porosity is provided. In FIG. 4A, there is illustrated a case in which the particles are chain-like particles 31. In FIG. 4B, there is illustrated a case in which the chain-like particles 31 and hollow particles 34 are both used as the particles.

A refractive index of the porous layer 2 is preferably 1.15 or more and 1.30 or less, more preferably 1.18 or more and 1.26 or less. When the refractive index is 1.15 or more, mechanical strength of the porous layer 2 is ensured. When the refractive index is 1.30 or lower, a difference in refractive index between air and the resin base material 1 is sufficiently reduced to thereby provide a sufficient anti-reflection effect.

A thickness Da of the surface layer 20b of the porous layer 2 is 80 nm or more and 150 nm or less, preferably 120 nm or less. Further, a depth Ds of the recessed portion 1b of the fine uneven structure (=the height of the protruding portion=the thickness of the composite layer 20a) is 10 nm or more and 120 nm or less as described above.

The composite layer 20a is particularly effective for improvement of the anti-reflection performance through interference with the surface layer 20b, which corresponds to an overlying layer, and also improves scratch resistance. When the porous layer 2 is formed on a smooth surface of the resin base material 1 without the fine uneven structure, film peeling of the porous layer 2 is liable to occur at an interface between the porous layer 2 and the resin base material 1. In the present invention, the porous material provided to fill the recessed portions of the fine uneven structure functions as an anchor, and hence the porous layer 2 is less liable to be peeled off and has high scratch resistance.

### (Particles)

As the particles contained in the porous layer 2, inorganic particles are preferably used. Specific examples thereof include silicon oxide particles, magnesium fluoride particles, lithium fluoride particles, calcium fluoride particles, and barium fluoride particles, and silicon oxide particles are preferred. Examples of a shape of the particle include a chain-like shape, a cocoon-like shape, a spherical shape, a disc-like shape, a rod-like shape, a needle-like shape, and a rectangular shape. When the refractive index of the porous layer 2 is to be decreased, chain-like particles or hollow particles, each having a pore surrounded by a shell, are preferred.

The chain-like particle is obtained as silicon oxide particles, and is a secondary particle corresponding to a series of a plurality of spherical particles being primary particles that are continuous linearly or in a bent pattern. The primary particles that form the chain-like particle may be such that an individual shape of each particle is clearly observable or is deformed due to fusion of the particles or the like. It is preferred that the individual shape of the primary particles be clearly observable. The primary particles of the chain-like particle may have a spherical shape, a cocoon-like shape, or a barrel-like shape. The cocoon-like shape or the barrel-like shape is particularly preferred, and a particle having a shorter diameter of 8 nm or more and 20 nm or less and a longer diameter being 1.5 times or more and 3.0 times or less the shorter diameter is particularly preferred.

A thickness of the chain-like particle corresponds to an average particle diameter of primary particles. The average particle diameter of the primary particles can be calculated from a specific surface area obtained by a nitrogen adsorption method for a chain-like particle extracted from an application liquid. It is preferred that the average particle diameter of the primary particles that form a chain-like silicon oxide particle be 8 nm or more and 20 nm or less. When the average particle diameter is 8 nm or more, a surface area of the chain-like particle is adequately reduced. As a result, a risk of reduction of reliability of the film due to uptake of water in an atmosphere or a chemical substance is eliminated. Further, when the average particle diameter is 20 nm or less, dispersion of the chain-like particle into a solvent becomes stable to thereby provide desirable applicability.

An average particle diameter of the chain-like particles corresponds to a Feret diameter of the secondary particle. The average particle diameter of particles in the application liquid can be obtained by a dynamic light scattering method. It is preferred that the average particle diameter of the chain-like particles be four or more times and eight or less times larger than the average particle diameter of the primary particles. When the average particle diameter of the chain-like particles is four or more times larger than the average particle diameter of the primary particles, the film does not become excessively dense. Thus, the refractive index can be sufficiently reduced. When the average particle diameter of the chain-like particles is eight or less times larger than the average particle diameter of the primary particles, a viscosity of the application liquid can be set to fall within an appropriate range to thereby provide desirable applicability and leveling property.

Further, the average particle diameter of the primary particles that form the chain-like particles of the chain-like silicon oxide particles contained in the porous layer 2 can be calculated from a transmission electron microscopic image or a scanning electron microscopic image.

As a method of forming hollow particles, a publicly known method described in Japanese Patent Application Laid-Open No. 2001-233611 or Japanese Patent Application Laid-Open No. 2008-139581 can be used for silicon oxide particles. Further, for magnesium fluoride particles, a publicly known method described in Japanese Patent Application Laid-Open No. 2012-76967 or Japanese Patent Application Laid-Open No. 2015-145325 can be used.

It is desired that an average particle diameter of the hollow particles be an average of 15 nm or more and 300 nm or less, preferably 30 nm or more and 80 nm or less. When the average particle diameter is 15 nm or more, the particles can be stably formed. When the average particle diameter is 300 nm or less, a void generated between the particles is not particularly large. Thus, scattering by the particles is reduced.

The average particle diameter of the hollow particles is an average Feret diameter. The average Feret diameter can be measured through image processing of a transmission electron microscopic image on which particles contained in the application liquid or particles contained in the porous layer 2 are observed. As an image processing method, commercially available image processing such as image ProPLUS (manufactured by Media Cybernetics) can be used.

The average Feret diameter can be obtained by measuring a Feret diameter of each of the particles in a predetermined image area through particle measurement while appropriately performing contrast adjustment as needed and calculating an average value of the plurality of particles.

A thickness of a shell of the hollow particle is 10% or more and 50% or less of the average particle diameter, preferably, 20% or more and 35% or less. When the thickness of the shell is 10% or more, the particle itself has sufficient strength. When the thickness of the shell is 50% or less, a ratio of an air gap to a volume of the particle is large. Thus, an effect of using the particles can be obtained. Specifically, the porous layer 2 having a refractive index of 1.30 or less can be formed.

An average particle diameter of particles other than the chain-like particles and the hollow particles can be obtained by the dynamic light scattering method when the average particle diameter of the particles contained in the application liquid is to be obtained. When the average particle diameter of the particles contained in the porous layer 2 is to be obtained, an average value of Feret diameters of a plurality of particles, which are measured from a transmission electron microscopic image or a scanning electron microscopic image, can be obtained as an average Feret diameter.

### (Binder)

When the particles 31, 34 are inorganic particles, it is preferred that the binder 32 that binds the particles 31, 34 be the same kind of inorganic material. The use of the same kind of material increases binding strength between the particles and allows formation of the porous layer that is less liable to be degenerated depending on an environment of use. Thus, when silicon oxide particles are used as the particles, it is preferred that the binder be a silicon oxide compound. Preferred examples of the silicon oxide compound include a cured product of a silicon oxide oligomer obtained by hydrolysis and condensation of silicic acid ester.

The amount of binder in the porous layer 2 is preferably 0.2 part by mass or more and 20 parts by mass or less, more preferably 1 part by mass or more and 10 parts by mass or less, desirably 2 parts by mass or more and 8 parts by mass or less with respect to 100 parts by mass of the particles contained in the porous layer 2. When the amount of binder is 0.2 part by mass or more, the particles sufficiently bind and thus the porous layer 2 has sufficient strength. When the amount of binder is 20 parts by mass or less, the binder does not disturb a particle arrangement. Thus, a low refractive index of the porous layer 2 with desirable scattering with respect to visible light can be obtained.

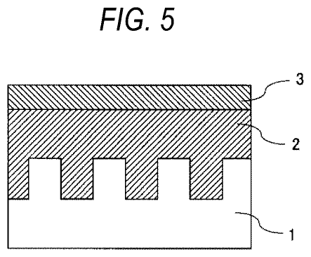

As illustrated in FIG. 5, the member according to the present invention may include a functional layer 3 such as an antifouling layer or a hydrophilic layer as needed. The functional layer 3 is formed on the porous layer 2, that is, a surface opposite to the resin base material 1. Examples of the antifouling layer include a layer containing a fluorine polymer, a fluorosilane monolayer, and a layer containing titanium oxide particles. As the hydrophilic layer, a hydrophilic polymer layer is preferred, and a layer containing a polymer having a zwitterionic hydrophilic group, such as a sulfobetaine group, a carbobetaine group, or a phosphorylcholine group, is particularly preferred.

The member according to the present invention can be suitably used as an optical element such as a lens, a mirror, a filter, or a functional film. Examples of the optical element include, in particular, those for a display device and an image pickup device, which are required to have high durability and high anti-reflection performance. Among them, the member is suitably used for a lens or a filter of a head mounted display (HMD), which is required to be reduced in weight, or the like.

### [Manufacturing Method]

Now, a method of manufacturing the member according to the present invention is described.

### (Resin Base Material)

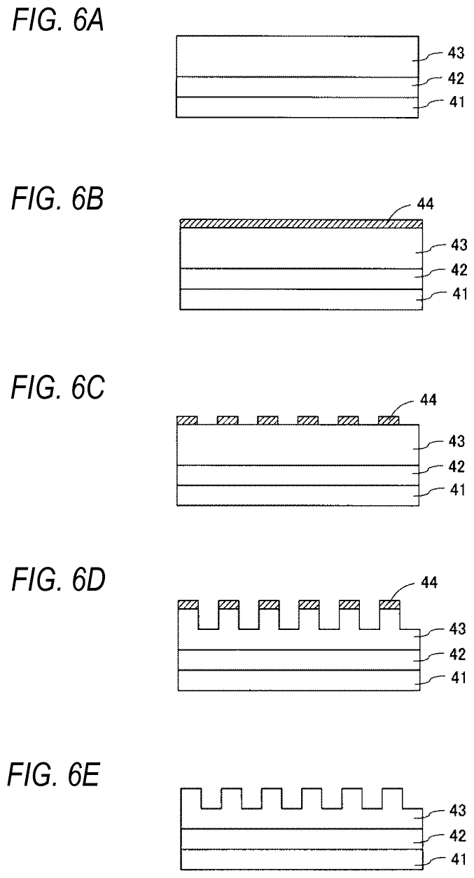

The resin base material having the fine uneven structure can be formed by injection molding or imprinting with use of a molding die having an inverted fine uneven structure. For a lens, a molding die having a fine uneven structure on a curved surface is required to be formed. In FIGS. 6A to 6E, a process of manufacturing a molding die having an inverted fine uneven structure is illustrated. FIGS. 6A to 6E are schematic sectional views taken in a thickness direction. With this method, a fine uneven structure can be formed on a mirror-finished die surface to control a refractive index and a layer thickness of the composite layer.

As illustrated in FIG. 6A, for the molding die for forming a fine uneven structure, after a plating film 42 made of NiP is grown on a base material 41 of a Stavax material, a surface of the plating film 42 is smoothed. Subsequently, after the surface of the plating film 42 is cleaned, a SiO₂ film 43 is grown uniformly by sputtering to a film thickness of 100 nm or more and 300 nm or less on the surface. In the sputtering, a Si target is used, and the film is grown while a ratio of an Ar gas and an O₂ gas is being finely adjusted. To control an etching depth for the SiO₂ film 43 by an etching selectively ratio for a film composition in dry etching performed in a subsequent step, a Si-rich film is formed on a side closer to the plating film 42 in the SiO₂ film 43. Further, the SiO₂ film 43 having a thickness equal to or more than a thickness corresponding to the height of the protruding portions or the depth of the recessed portions of the fine uneven structure is formed on a side farther from the plating film 42.

As illustrated in FIG. 6B, a photoresist 44 is applied onto the SiO₂ film 43 by spin coating so as to have a uniform film thickness. Then, a drying treatment such as pre-bake is performed.

A pattern corresponding to the protruding portions or the recessed portions of the uneven structure is drawn on the photoresist 44 in a normal direction to the mirror-finished curved die surface by electronic beam lithography. A sectional shape or a size of, or a distance between the protruding portions or the recessed portions of the fine uneven structure, that is, the refractive index of the composite layer can be adjusted by the electronic beam lithography. A thickness of the photoresist 44 used in a lithography step is correlated with the fine uneven structure formed on the mirror-finished die surface. More specifically, when the height is 80 nm, a thickness of 60 nm or more is required based on the selectivity ratio in the dry etching. For the photoresist 44, interfacial reflection is reduced at appropriate time by a treatment such as a bottom anti-reflective coating (BARC) or top anti-reflective coating (TARC) in accordance with specifications of a lithography device.

After the molding die, which has been subjected to the lithography, is immersed into a developer to form a lithography pattern thereon, a post-bake treatment is performed. In this manner, a similar pattern, which corresponds to a reduced pattern of the fine uneven structure to be formed by dry etching in a height direction, is formed on the photoresist 44 on the SiO₂ film 43 (FIG. 6C).

As illustrated in FIG. 6D, the SiO₂ film 43 is etched by the amount corresponding to the height of the protruding portions or the depth of the recessed portions by dry etching using a CHF₃ gas and using the photoresist 44 as a mask to thereby form an inverted fine uneven structure on the mirror-finished die surface. The height of the protruding portions or the depth of the recessed portions can be controlled by the film thickness of the SiO₂ film 43 and dry etching time.

After the dry etching, an ashing treatment with an oxygen gas is performed to remove a residue of the photoresist 4. As a result, a mirror-finished injection-molding die including the SiO₂ film 43 having the inversed fine uneven structure is formed (FIG. 6E).

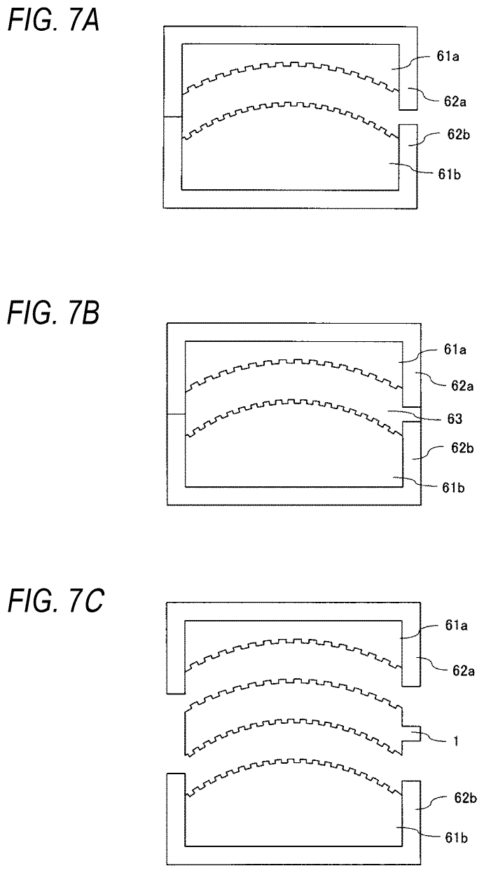

Next, a manufacturing method for the resin base material through injection molding using the molding die formed through the process of FIGS. 6A to 6E is described with reference to FIGS. 7A to 7C. FIGS. 7A to 7C are schematic sectional views for illustrating a process of manufacturing the member illustrated in FIG. 1A, which is taken in the thickness direction.

When the member including the anti-reflection structures 20 on both surfaces of the base material layer 10 is to be formed, molding dies 61a and 61b, each having the inverted fine uneven structure on a side corresponding to each of the surfaces of the base material layer 10, are prepared as illustrated in FIG. 7A so as to form the fine uneven structure on both surfaces. The molding dies 61a and 61b are incorporated into a fixed-side die 62a and a movable-side die 62b of an injection molding device, respectively. Any of the dies may serve as a fixed-side one. When the surfaces of the resin base material 1 are curved, the protruding portions or the recessed portions of the fine uneven structure are formed in a normal direction of the curved surface.

Next, as illustrated in FIG. 7B, an uncured resin 63 is injected into a gap between the molding dies 61a and 61b. As the resin for injection molding, a thermoplastic resin such as a cycloolefin resin, a polycarbonate resin, or a poly methacrylic acid acrylic resin, which has a low water-absorbing property, can be used. Among them, it is preferred to use a cycloolefin resin, which has a low water-absorbing property. When the cycloolefine resin is used, a molten resin temperature is preferably 250° C. or more and 290° C. or less and a temperature of the dies is preferably 125° C. or more and 140° C. or less, and it is preferred that molding be carried out at a holding pressure of 20 MPa or more and 90 MPa or less.

After cooling is performed so that a molding resin temperature is decreased to a temperature equal to or lower than a glass transition temperature, a molded product is released from the dies with use of ejector pins while being prevented from being inclined. As a result, the resin base material 1 having the fine uneven structures on both surfaces is obtained.

When a lens having a small opening angle (lens close to a plane) is to be injection-molded and the lens is released from the dies, for example, in a direction corresponding to an optical axis direction of the lens, the lens can be formed regardless of the height of the protruding portions or the depth of the recessed portions of the fine uneven structure. For injection-molding of a lens having a large opening angle, however, when a portion of the fine uneven structure, which includes protruding portions or recessed portions each having a columnar shape with a center axis not being parallel to the optical axis, is released from the dies, the fine uneven structure may be deformed and a structural distribution that greatly changes a reflectance may be generated. In the present invention, however, the height of the protruding portions or the depth of the recessed portions is 120 nm or less. Thus, strain that is caused at the time of releasing from the dies can be absorbed by elastic deformation of the resin base material 1, and hence does not cause any problems.

### (Porous Layer)

Next, after a description of the application liquid to be used for formation of the porous layer, a method of forming the anti-reflection structure is described.

### (Application Liquid)

The application liquid for forming the porous layer 2 contains particles of the porous material, a binder component for binding the particles to each other, and an organic solvent. With the application liquid in which the particles are uniformly dispersed, a space defined by the protruding portions or the recessed portions of the fine uneven structure can be uniformly filled with the particles when the solvent dries slowly after the application. When the particles are present in an aggregated state under the effects of a dispersion medium or a component serving as the binder, the particles less easily move into the space between the fine protruding portions or into the fine recessed portions. Further, when the drying speed of the application liquid greatly differs on the fine uneven structure side and on the side opposite thereto in a drying process after the application, the space defined by the protruding portions or the recessed portions of the fine uneven structure is insufficiently filled with the particles, and hence the air gap in the filling portion is more liable to be increased in size. Further, when the air gap defined by the protruding portions or the recessed portion is increased in size, an anchor effect of the porous layer 2 is reduced, resulting in decreased scratch resistance.

It is preferred that the binder be made of the same kind of material as that of the particles. Thus, when silicon oxide particles are used as the particles, it is preferred that the binder be a silicon oxide compound. The silicon oxide particle has a silanol (Si—OH) group in its surface. The number of silanol groups in the surface of the silicon oxide particle can be further increased by mixing the silicon oxide particles with a silicon oxide oligomer in the application liquid. As a result, a surface state in which the particles are more likely to be bound to each other can be achieved. After the application liquid is applied and dried, the silicon oxide oligomer binds a plurality of particles together. Thus, the porous layer 2 having high scratch resistance can be formed.

The amount of the component serving as the binder contained in the application liquid in the present invention is the same as that in the above-mentioned composition of the porous layer 2.

The organic solvent that can be used for the application liquid may be any solvents that do not cause the particles to precipitate or do not cause the application liquid to be suddenly thickened. Examples of the organic solvent include the following solvents. Examples thereof include: monohydric alcohols, such as methanol, ethanol, 1-propanol, 2-propanol, 1-butanol, 2-butanol, 2-methylpropanol, 1-pentanol, 2-pentanol, cyclopentanol, 2-methylbutanol, 3-methylbutanol, 1-hexanol, 2-hexanol, 3-hexanol, 4-methyl-2-pentanol, 2-methyl-1-pentanol, 2-ethylbutanol, 2,4-dimethyl-3-pentanol, 3-ethylbutanol, 1-heptanol, 2-heptanol, 1-octanol, and 2-octanol; dihydric or higher alcohols, such as ethylene glycol and triethylene glycol; ether alcohols, such as methoxyethanol, ethoxyethanol, propoxyethanol, isopropoxyethanol, butoxyethanol, 1-methoxy-2-propanol, 1-ethoxy-2-propanol, 1-propoxy-2-propanol, and 3-methoxy-1-butanol; ethers, such as dimethoxyethane, diglyme (diethylene glycol dimethyl ether), tetrahydrofuran, dioxane, diisopropyl ether, dibutyl ether, and cyclopentyl methyl ether; esters, such as ethyl formate, ethyl acetate, n-butyl acetate, methyl lactate, ethyl lactate, ethylene glycol monomethyl ether acetate, ethylene glycol monoethyl ether acetate, ethylene glycol monobutyl ether acetate, and propylene glycol monomethyl ether acetate; various aliphatic or alicyclic hydrocarbons, such as n-hexane, n-octane, cyclohexane, cyclopentane, and cyclooctane; various aromatic hydrocarbons, such as toluene, xylene, and ethylbenzene; various ketones, such as acetone, methyl ethyl ketone, methyl isobutyl ketone, cyclopentanone, and cyclohexanone; various chlorinated hydrocarbons, such as chloroform, methylene chloride, carbon tetrachloride, and tetrachloroethane; and aprotic polar solvents, such as N-methylpyrrolidone, N,N-dimethylformamide, N,N-dimethylacetamide, and ethylene carbonate. Of those solvents, two or more kinds thereof can also be mixed to be used.

In terms of dispersibility of the particles and applicability of the application liquid, it is preferred that 30% by mass or more of the solvent contained in the application liquid be a water-soluble solvent having a hydroxy group with four or more and six or less carbon atoms and a high boiling point. Of those, at least one kind of solvent selected from the group consisting of: ethoxyethanol; propoxyethanol; isopropoxyethanol; butoxyethanol; 1-methoxy-2-propanol; 1-ethoxy-2-propanol; ethyl lactate; and 3-methoxy-1-butanol is particularly preferably included.

### (Formation of Porous Layer)

The porous layer 2 is formed through a step of applying the application liquid onto the resin base material 1 and a step of drying and/or baking the application liquid. As a method of applying the application liquid to the resin base material 1, there are given a spin coating method, a blade coating method, a roll coating method, a slit coating method, a printing method, a gravure coating method, a dip coating method, and the like. When a member having a three-dimensionally complicated shape, such as a recessed surface, is manufactured, the spin coating method is preferred because it is easy to apply the application liquid to a uniform thickness.

The step of drying and/or baking the application liquid is not limited to any particular one.

### EXAMPLES

The resin base material having the fine uneven structure was formed by injection molding using the molding dies having the inverted fine uneven structure. The distance P between the recessed portions was set to 250 nm. A cycloolefine resin was used as the resin material. The molding was carried out at a molten resin temperature of 270° C., a die temperature of 130° C., and a holding pressure of 50 MPa. After the molten resin was injected, cooling was performed by reducing a molded resin temperature to a temperature equal to or lower than a glass transmission temperature. After that, a molded product was released from the dies by using the ejector pins while being prevented from being inclined. In this manner, the resin base material having the fine uneven structure was formed.

The application liquid was prepared for and applied onto the resin base material of each Example to thereby form the porous layer. An evaluation method is described below.

### (Evaluation of Size of Fine Uneven Structure)

Using a high-resolution SEM apparatus with a FIB, a cross section exposing process (Slice) with the FIB and observation (View) with the SEM were repeated at short intervals. A three-dimensional size of the fine uneven structure was evaluated by reconstructing the acquired images.

### (Evaluation of Reflectance of Anti-Reflection Structure)

A reflectance was measured at a wavelength of from 380 nm to 780 nm by using a reflectance measuring device (USPM-RUIII manufactured by Olympus Corporation).

### (Evaluation of Refractive Index of Porous Layer)

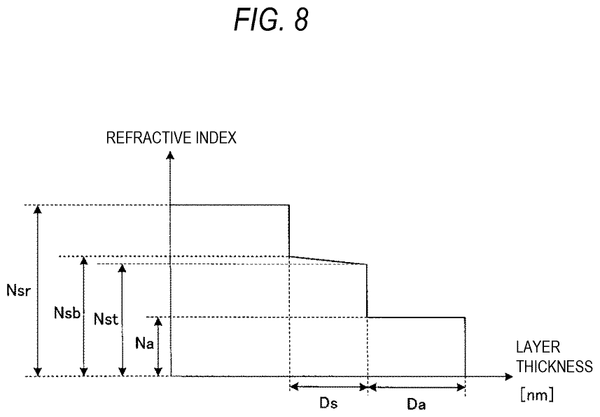

A refractive index of the porous layer was obtained through analysis using the results about the size of the fine uneven structure and the reflectance. A refractive-index model of the anti-reflection structure used in the analysis was shown in FIG. 8.

In FIG. 8, a horizontal axis represents a layer thickness, Da represents a layer thickness of the surface layer of the porous layer, and Ds represents a layer thickness of the composite layer. The results of evaluation obtained by the high-resolution SEM apparatus with the FIB were used. Further, a vertical axis represents a refractive index. Nsr represents a refractive index (1.537) of a cycloolefine polymer. Na represents a refractive index of the porous layer. Nsb represents a complex refractive index on a bottom (on the resin base material side) of the fine uneven structure, and Nst represents a complex refractive index on a top (on the surface layer side) of the fine uneven structure.

The complex refractive index was expressed by Maxwell-Garnett equation, and a value obtained from the results of evaluation performed with the high-resolution SEM apparatus with the FIB was used as a volume fraction of a solid in the equation. Further, the refractive index of the porous layer was obtained, regarding the refractive index of the porous layer of the fine uneven structure, that is, the refractive index of the filling portion as being the same as the refractive index of the surface layer of the porous layer.

### (Evaluation of Scratch Resistance)

Scratch resistance of the anti-reflection structure was evaluated by the following method. A dry sweeping test with fifty reciprocating movements was conducted with lens-cleaning paper, and film peeling and a flaw were visually checked. In the check, a load was increased from 100 g/cm² by an increment of 100 g/cm² until film peeling or a flaw was observed. For example, when film peeling or a flaw was observed after the dry sweeping test with fifty reciprocating movements under a load of 500 g/cm², scratch resistance was evaluated to be 400 g/cm².

### Example 1

A resin base material having recessed portions, which each had a columnar shape and were arranged in a triangular lattice pattern as the fine uneven structure, was formed. The application liquid for forming the porous layer was prepared by the following method, and the porous layer was formed on the resin base material to thereby form the member having the anti-reflection structure.

Isopropyl alcohol was heated and distilled while 1-propoxy-2-propanol was being added to 400 g of a chain-like silicon oxide particle-dispersed isopropyl alcohol liquid (IPA-ST-UP manufactured by Nissan Chemical Corporation: particle diameter of 40 nm, solid content concentration of 15% by mass). The isopropyl alcohol was distilled until the solid content concentration reached 30% by mass to thereby prepare 200 g of a 1P2P solvent replacement liquid of chain-like silicon oxide particles (hereinafter referred to as “solvent replacement liquid 1”). As a result of measurement by the dynamic light scattering method, a peak value of a particle diameter distribution of the chain-like silicon oxide particles was 40 nm, an average particle diameter of the primary particles was 10 nm, and a longer diameter of the secondary particles was from 40 nm to 100 nm.

In another container, 13.82 g of ethanol and a nitric acid aqueous solution (concentration of 3%) were added to 12.48 g of ethyl silicate and were stirred at room temperature for ten hours to prepare a silica sol 1 (solid content concentration of 11.5% by mass). It was confirmed through gas chromatography that ethyl silicate corresponding to a raw material had completely reacted.

After the solvent replacement solution 1 was diluted with ethyl lactate so that the solid content concentration was reduced to 5.0% by mass, the silica sol 1 was added so that a mass ratio of the silicon oxide particles and a silica sol component became equal to 100:5. Further, after mixing and stirring were performed at room temperature for two hours, the application liquid 1 containing the chain-like silicon oxide particles was obtained.

The thus obtained application liquid 1 was dropped onto the resin base material, and a film was grown thereon with a spin coater. After that, the resin base material was baked on a hot plate at 100° C. for five minutes to thereby form the member having the anti-reflection structure.

After that, the reflectance was evaluated. An average reflectance at a wavelength of from 400 nm to 700 nm was 0.12%. The scratch resistance was evaluated to be 400 g/cm².

After that, the size of the fine uneven structure was evaluated with the high-resolution SEM apparatus with the FIB. The layer thickness Da of the surface layer of the porous layer was 91 nm, and the depth Ds of the recessed portions was 60 nm. Further, the sectional shape of the recessed portion having a columnar shape with the center axis had, as exemplified in FIG. 4A, a side surface slightly flared toward an upper part (opening portion), and the side surface was linear and was inclined at an opening angle θs of 3 degrees. The size Ls corresponding to a diameter of a center portion of the recessed portion in a depth direction was 151 nm. The refractive index of the porous layer calculated from the refractive-index model was 1.20.

### Example 2

The resin base material including the recessed portions having a different size from that of Example 1 was formed. A member having the anti-reflection structure was formed under the same conditions as those in Example 1 except that the mass ratio of the silicon oxide particles and the silica sol component in the application liquid 1 was set to 100:10.

The thus obtained member was evaluated. As the evaluation of the reflectance, the average reflectance at the wavelength of from 400 nm to 700 nm was 0.12%. The scratch resistance was evaluated to be 400 g/cm².

Further, the size of the fine uneven structure was evaluated with the high-resolution SEM apparatus with the FIB. The layer thickness Da of the surface layer was 90 nm, and the depth Ds of the recessed portions was 49 nm. Further, a cross section of the recessed portion having a columnar shape with the center axis had a shape as illustrated in FIG. 4A, and a side surface of the sectional shape was linear and was inclined at the opening angle θs of 3 degrees. The size Ls corresponding to a diameter of a center portion of the recessed portion in the depth direction was 153 nm. The refractive index of the porous layer calculated from the refractive-index model was 1.22.

### Example 3

The resin base material including the recessed portions having a different size from that of Example 1 was formed. A member having the anti-reflection structure was formed under the same conditions as those in Example 1 except that the mass ratio of the silicon oxide particles and the silica sol component in the application liquid 1 was set to 100:15.

The thus obtained member was evaluated. As the evaluation of the reflectance, the average reflectance at the wavelength of from 400 nm to 700 nm was 0.18%. The scratch resistance was evaluated to be 400 g/cm².

Further, the size of the fine uneven structure was evaluated with the high-resolution SEM apparatus with the FIB. The layer thickness Da of the surface layer was 91 nm, and the depth Ds of the recessed portions was 26 nm. Further, a cross section of the recessed portion having a columnar shape with the center axis had a shape as illustrated in FIG. 4A, and a side surface of the sectional shape was linear and was inclined at the opening angle θs of 3 degrees. The size Ls corresponding to a diameter of a center portion of the recessed portion in the depth direction was 172 nm. The refractive index of the porous layer calculated from the refractive-index model was 1.26.

### Example 4

A member having the anti-reflection structure was formed under the same conditions as those in Example 1 except that the resin base material was formed under the same conditions as those in Example 3 and an application liquid 2 was prepared by the following method.

A hollow silicon oxide particle-dispersed isopropyl alcohol liquid was added to the solvent replacement liquid 1 obtained in the same manner as in Example 1 so that a mass ratio of the chain-like silicon oxide particles and the hollow silicon oxide particles became equal to 2:1 to thereby obtain a dispersion liquid 2. As the hollow silicon oxide particle-dispersed isopropyl alcohol liquid, Thrulya 4110 manufactured by JGC Catalysts and Chemicals Ltd., average particle diameter (Feret diameter) of about 60 nm, shell thickness of about 10 nm, solid content concentration of 20.5% by mass was used. Further, the silica sol 1 was prepared in the same manner as in Example 1.

After the dispersion liquid 2 was diluted with ethyl lactate so that the solid content concentration was reduced to 5.0% by mass, the silica sol 1 was added so that a mass ratio of the silicon oxide particles and a silica sol component became equal to 100:10. Further, after mixing and stirring were performed at room temperature for two hours, the application liquid 2 containing the chain-like silicon oxide particles and the hollow silicon oxide particle was obtained.

The thus obtained member was evaluated. As the evaluation of the reflectance, the average reflectance at the wavelength of from 400 nm to 700 nm was 0.15%. The scratch resistance was evaluated to be 500 g/cm².

Further, the size of the fine uneven structure was evaluated with the high-resolution SEM apparatus with the FIB. The layer thickness Da of the surface layer was 105 nm, and the depth Ds of the recessed portions was 26 nm. Further, a cross section of the recessed portion having a columnar shape with the center axis had a shape as illustrated in FIG. 4A, and a side surface of the sectional shape was linear and was inclined at the opening angle θs of 3 degrees. The size Ls corresponding to a diameter of a center portion of the recessed portion in the depth direction was 172 nm.

In this example, a ratio of the hollow particles in the porous material was different between the filling portion in the recessed portions and the surface layer. The hollow particles were preferentially arrayed on the surface layer side, and thus the scratch resistance was improved. It is considered that the scratch resistance was improved because the array of hollow particles in an uppermost layer improved lubricity and the mixture with the chain-like particles ensured sufficient adhesion strength to the resin base material.

The refractive index of the porous layer, which served as a reference, was evaluated by the following method. The application liquid 2 was applied onto a silicon wafer and baked under the same conditions as those in Examples under which the porous layer was formed on the resin base material. Light was radiated on the porous layer by using a spectroscopic ellipsometer (VASE manufactured by J.A. Woollam Japan). Reflected light by the porous layer was measured at a wavelength of from 380 nm to 800 nm to calculate the refractive index. The calculated refractive index was 1.21.

### Comparative Example 1

A member having the anti-reflection structure was formed under the same conditions as those in Example 2 except that the resin base material including the recessed portions having a different size from that of Example 1 was formed.

The thus obtained member was evaluated. As the evaluation of the reflectance, the average reflectance at the wavelength of from 400 nm to 700 nm was 1.10%. The scratch resistance was evaluated to be 400 g/cm².

Further, the size of the fine uneven structure was evaluated with the high-resolution SEM apparatus with the FIB. The layer thickness Da of the surface layer was 90 nm, and the depth Ds of the recessed portions was 130 nm. Further, a cross section of the recessed portion having a columnar shape with the center axis had a shape as illustrated in FIG. 4A, and a side surface of the sectional shape was linear and was inclined at the opening angle θs of 3 degrees. The size Ls corresponding to a diameter of a center portion of the recessed portion in the depth direction was 153 nm. The refractive index of the porous layer calculated from the refractive-index model was 1.22.

It is considered that the reason why the member of this comparative example had a larger reflectance than that of Example 2 was because an excessively large depth of the recessed portions reduced a reflection suppressing effect in interference.

### Comparative Example 2

A member having the anti-reflection structure was formed under the same conditions as those in Example 2 except that the solvent replacement solution 1 was diluted with ethyl lactate so that the solid content concentration of the application liquid was reduced to 7.0% by mass.

The thus obtained member was evaluated. As the evaluation of the reflectance, the average reflectance at the wavelength of from 400 nm to 700 nm was 2.70%. The scratch resistance was evaluated to be 400 g/cm².

Further, the size of the fine uneven structure was evaluated with the high-resolution SEM apparatus with the FIB. The layer thickness Da of the surface layer was 160 nm, and the depth Ds of the recessed portions was 49 nm. Further, a cross section of the recessed portion having a columnar shape with the center axis had a shape as illustrated in FIG. 4A, and a side surface of the sectional shape was linear and was inclined at the opening angle θs of 3 degrees. The size Ls corresponding to a diameter of a center portion of the recessed portion in the depth direction was 153 nm. The refractive index of the porous layer calculated from the refractive-index model was 1.22.

It is considered that the reason why the member of this comparative example had a larger reflectance than that of Example 2 is because an excessively large thickness of the surface layer of the porous layer reduced a reflection suppressing effect in interference.

### Comparative Example 3

The dry etching conditions for forming the fine uneven structure on the injection molding die were changed so as to form a fine uneven structure including conical protruding portions. Injection molding was carried out with the molding dies to form a resin base material including conical recessed portions arranged in a triangular lattice pattern. A member having the anti-reflection structure was formed under the same conditions as those in Example 3 except that the thus obtained resin base material was used.

The thus obtained member was evaluated. As the evaluation of the reflectance, the average reflectance at the wavelength of from 400 nm to 700 nm was 1.15%. The scratch resistance was evaluated to be 600 g/cm².

A size of the fine uneven structure was evaluated with the high-resolution SEM apparatus with the FIB. The recessed portion had a truncated conical shape flared toward its opening portion. A minimum diameter of a bottom (on the resin base material side) of the recessed portion was 5 nm, and a maximum diameter of the recessed portion on its top (on the porous layer side of the surface layer) was 245 nm. The top of the recessed portion and a surface of the filling portion were substantially flush with each other. The fine uneven structure had no surface layer portion (Da=0), and the depth Ds of the recessed portions was 350 nm. A refractive index of the porous layer calculated from the refractive-index model for the depth was 1.26.

The anti-reflection structure of this comparative example was a refractive-index gradient structure. For such a structure, a moth-eye structure with unfilled recessed portions is optimal. Filling the recessed portions with the porous material improved the scratch resistance. However, the anti-reflection performance degraded at the same time.

### Comparative Example 4

A member having an anti-reflection structure was formed under the same conditions as those in Example 3 except that a resin base material was formed with use of molding dies without a fine uneven structure.

The thus obtained member was evaluated. As the evaluation of the reflectance, the average reflectance at the wavelength of from 400 nm to 700 nm was 0.50%. The scratch resistance was evaluated to be 100 g/cm².

A film thickness and a refractive index of a porous layer were measured by using the spectroscopic ellipsometer (VASE manufactured by J.A. Woollam Japan) and were calculated from a single-layer model. The film thickness was 90 nm, and the refractive index was 1.26.

The results of Examples and Comparative Examples are shown in Table 1.

TABLE 1

| | | | Recessed portion | | | | |
|---|---|---|---|---|---|---|---|
| | | | | | | | Volume ratio |
| | | Thickness | | | | Average | [%] in |
| | | Da [nm] of | | Depth Ds | Pitch P | diameter | composite |
| | Particles | surface layer | Shape | [nm] | [nm] | [nm] | layer |
| Example 1 | Chain-like | 91 | Columnar | 60 | 250 | 151 | 33 |
| | shape | | shape | | | | |
| Example 2 | Chain-like | 90 | Columnar | 49 | 250 | 153 | 34 |
| | shape | | shape | | | | |
| Example 3 | Chain-like | 91 | Columnar | 26 | 250 | 172 | 43 |
| | shape | | shape | | | | |
| Example 4 | Chain-like | 105 | Columnar | 26 | 250 | 172 | 43 |
| | shape + | | shape | | | | |
| | hollow | | | | | | |
| Comparative | Chain-like | 90 | Columnar | 130 | 250 | 153 | 34 |
| example 1 | shape | | shape | | | | |
| Comparative | Chain-like | 160 | Columnar | 49 | 250 | 153 | 34 |
| example 2 | shape | | shape | | | | |
| Comparative | Chain-like | 0 | Truncated | 350 | 250 | — | 26 |
| example 3 | shape | | conical | | | | |
| | | | shape | | | | |
| Comparative | Chain-like | 90 | — | — | — | — | — |
| example 4 | shape | | | | | | |

| | Average | Refractive | Scratch |
|---|---|---|---|
| | reflectance | Index of | Resistance |
| | [%] | porous layer | [g/cm²] |
| Example 1 | 0.12 | 1.20 | 400 |
| Example 2 | 0.12 | 1.22 | 400 |
| Example 3 | 0.18 | 1.26 | 400 |
| Example 4 | 0.15 | 1.21 | 500 |
| Comparative | 1.10 | 1.22 | 400 |
| example 1 | | | |
| Comparative | 2.70 | 1.22 | 400 |
| example 2 | | | |
| Comparative | 1.15 | 1.26 | 600 |
| example 3 | | | |
| Comparative | 0.50 | 1.26 | 100 |
| example 4 | | | |

According to the present invention, the member including the resin base material, which is excellent in anti-reflection performance and is formed without using the vacuum process can be achieved.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A member comprising:
a resin base material having a surface with a fine uneven structure; and
a porous layer made of a porous material containing particles formed on the resin base material so as to be positioned on the fine uneven structure side,
wherein the porous layer includes:
a filling portion defined by the porous material in an air gap of the fine uneven structure; and
a surface layer located on the fine uneven structure,
wherein a thickness of the surface layer is 150 nm or less,
wherein a height of the protruding portions or a depth of the recessed portions is 120 nm or less.

2. The member according to claim 1, a distance between the protruding portions or the recessed portions is 20 nm or more and 300 nm or less.

3. The member according to claim 1, wherein a refractive index of the porous layer is 1.15 or more and 1.30 or less.

4. The member according to claim 1, wherein a refractive index of the porous layer is 1.18 or more and 1.26 or less.

5. The member according to claim 1, wherein a volume ratio of the filling portion to the fine uneven structure is from 30% to 50%.

6. The member according to claim 1, wherein an average reflectance at the wavelength of from 400 nm to 700 nm is less than 0.50%.

7. The member according to claim 1, wherein the thickness of the surface layer is 120 nm or less.

8. The member according to claim 1, wherein the thickness of the surface layer is 80 nm or more.

9. The member according to claim 1, wherein the height of the protruding portions or the depth of the recessed portions is 10 nm or more.

10. The member according to claim 1, wherein the resin base material is made of any one of a cycloolefin resin, a polycarbonate resin and a poly methacrylic acid acrylic resin.

11. The member according to claim 1, wherein the particles are made of silica.

12. The member according to claim 11, wherein the particles are chain-like particles.

13. The member according to claim 11, wherein the particles are chain-like particles and hollow particles.

14. The member according to claim 1, further comprising a glass base material,
wherein the resin base material is laminated on the glass base material.

15. A member comprising:
a resin base material having a surface with a fine uneven structure; and
a porous layer made of a porous material containing particles formed on the resin base material so as to be positioned on the fine uneven structure side,
wherein the porous layer includes:
a filling portion defined by the porous material in an air gap of the fine uneven structure; and
a surface layer located on the fine uneven structure,
wherein an average reflectance at the wavelength of from 400 nm to 700 nm is less than 0.50%.
